(19) United States
(12) Patent Application Publication
(10) Pub. No.: US 2023/0337711 A1
(43) Pub. Date: Oct. 26, 2023

(54) FOOD GRADE COATING FOR EDIBLE MOISTURE-SENSITIVE PARTICULATES

(71) Applicant: MANTROSE-HAEUSER CO., INC., Westport, CT (US)

(72) Inventors: Xiangdong GAN, Franklin, MA (US); Michael MCNELLY, Westport, CT (US)

(21) Appl. No.: 18/006,262

(22) PCT Filed: Jul. 20, 2021
(86) PCT No.: PCT/US2021/042307

§ 371 Date: Jan. 20, 2023

Related U.S. Application Data
(60) Provisional application No. 63/053,856, filed on Jul. 20, 2020.

(51) Int. Cl. A23P 20/10; A23P 20/13

(52) U.S. Cl. CPC A23P 20/11; A23P 20/105; A23P 20/13

(57) ABSTRACT

A protective coating for edible moisture-sensitive granular particulates can comprise at least two different coating layers, at least one being formed from a wax coating layer and at least one being formed from a shellac coating layer. The protective coating can exhibit excellent barrier properties even if the protective coating is made very thin or if the edible particulates being protected are irregular in shape.

### CROSS-REFERENCE TO RELATED APPLICATIONS

This application claims priority to and the benefit of U.S. Provisional Patent Application No. 63/053,856, filed on Jul. 20, 2020, the entire content of which is incorporated herein by reference.

### BACKGROUND

A wide variety of different materials have been used to provide protective coatings on edible, moisture-sensitive particulates. An important property of any such coating is barrier properties, i.e., the ability of the coating to act as a barrier preventing the transmission of gases and/or liquids through the coating. Another important property is ease of application, i.e., the ability of the coating to be applied by a simple and hence inexpensive coating process. Still another important property is coating uniformity, i.e., the ability of the protective coating to be applied with uniform thickness, especially when thinner coatings are desired.

Providing protective coatings on edible particulates which are, or contain, moisture-sensitive ingredients such as sugars, starches, food grade acids and moisture-sensitive dyes has proven to be especially difficult. This is, because such materials can absorb and/or dissolve in moisture from the atmosphere which can pass through the protective coating if its barrier properties are insufficient. Not only can this destroy the physical integrity of the particulate but, in addition, it can also lead to “bleed out” of ingredients from the particulate, i.e., migration of these ingredients back out of the particulate through its protective coating, such as can occur, for example, if the particulate is a food grade acid or contains a moisture-sensitive dye.

U.S. Pat. No. 2,956,926 attempts to deal with this problem by pan coating citric acid powder with a waxy material dissolved in a suitable volatile, halogenated organic solvent such as 1,1,1-trichloroethane, chloroform, carbon tetrachloride, other volatile halogenated hydrocarbons, petroleum ether, etc. However, this approach is unsatisfactory from a health and safety standpoint.

Another approach for dealing with this problem is spray coating in which a liquid hydrophobic coating material such as a fat, oil or wax is sprayed on a stationary bed of particulates, following which the spray-coated particulates are dried. In a similar approach, the particulates are combined with the liquid hydrophobic coating material, and the mixture so-obtained then spray dried to form encapsulated particulates. These techniques, however, normally require that large amounts of coating material be used to achieve complete coating of the particulates and it appears additional ingredients in the coating material such as emulsifiers, thickeners and antifoam agents and/or multiple coating steps are necessary to achieve a uniform coating.

Still another approach for dealing with this problem are fluidized bed coating techniques in which fine liquid droplets of the coating material are sprayed onto the particulates while they are suspended in an up-flowing gas stream. Unfortunately, fluidized bed coating techniques are inherently complex and therefore require expensive equipment as well as precise process control. In addition, relatively large amounts of coating material are often needed to achieve complete coating encapsulation when these techniques are used. See, Xu et al., Hot-Melt Fluidized Bed Encapsulation of Citric Acid with Lipid, International Journal of Food Engineering, 2017, 20160247, © 2017 Walter de Gruyter GmbH Berlin/Boston.

### SUMMARY

In accordance with this invention, it has been found that protective coatings for edible moisture-sensitive particulates which coatings comprise at least two different coating layers, at least one being formed from wax and at least one being formed from shellac, exhibit excellent barrier properties even though these protective coatings can be made very thin and even though the particulates being protected are irregular in shape.

Thus, this invention provides a granular food product comprising a moisture-sensitive edible particulate substrate and a protective coating on the particulate substrate comprising one or more wax coating layers and one or more shellac coating layers, wherein the total amount of the wax coating layers in the granular food product is no more than 10 wt. %, wherein the total amount of the shellac coating layers in the granular food product is no more than 15 wt. %, and the total amount of the protective coating in the granular food product is no more than 20 wt. %, these percentages being based on the weight of the edible moisture-sensitive particulate substrate.

In addition, this invention also provides a process for making the above granular food product, wherein each of the one or more wax coating layers and each of the one or more shellac coating layers is formed by a pan coating technique.

Still further, this invention also provides a process for making a granular food product comprising an edible moisture-sensitive particulate substrate and a protective coating on the particulate substrate comprising one or more wax coating layers and one or more shellac coating layers, the process comprising applying the one or more shellac coating layers to the particulate by pan coating techniques in which a liquid coating composition is applied to a batch of particulate materials being carried in the rotating pan of a pan coating machine, applying the one or more wax coating layers in a powdered form to the particulate, followed by solidification of the liquid coating composition to form the solid protective coating, wherein during application of at least one shellac coating layer a declumping drum having an essentially circular periphery is allowed to roll over the contents of the rotating pan thereby breaking apart and helping to comminute any agglomerates that may have formed.

### BRIEF DESCRIPTION OF THE DRAWINGS

FIG. 1 illustrates a declumping drum that can be used to help break up any unwanted agglomerates that may form when the protective coatings of this invention are applied.

### DETAILED DESCRIPTION

### Edible Moisture-Sensitive Particulates

This invention provides a simple, efficient and inexpensive technique for applying protective coatings with good barrier properties to edible moisture-sensitive particulates, especially those having a particle size of at least 200 mesh (74 microns) or larger and especially those having an irregular shape. For this purpose, an edible particulate will be understood to be “moisture-sensitive” if it absorbs moisture from its surroundings during the life cycle of the food product and becomes unsuitable or undesirable for its intended application as a food product. One of ordinary skill in the art as well as an ordinary consumer or user of the food product would readily be able to recognize when the food product becomes unsuitable or undesirable for its intended application. This invention is particularly useful in connection with applying such protective coatings to edible particulates which are hygroscopic. In this context, an edible particulate will be understood to be “hygroscopic” if the reason why it becomes unsuitable or undesirable when exposed to moisture is due to substantial change in at least one of its physical properties, including, but not limited to, volume, shape, coarseness, and crush strength.

One type of edible particulate that can be coated in accordance with this invention can be regarded as an ingredient or raw material for other food products which ingredient, itself, is moisture-sensitive and/or hygroscopic. Examples of this type of particulate include organic (food grade) acids such as citric acid, malic acid, tartaric acid, ascorbic acid, and fumaric acid; saccharides such as sucrose, glucose including anhydrous glucose, dextrose, invert sugar, maltodextrin, dextrin, fructose, lactose, and sugar alcohols such as sorbitol, mannitol, erythritol and xylitol; and granulated sweeteners that are liquid in origin such as honey and corn syrup. Combinations of these ingredients can also be used to produce edible particulates of the present disclosure. In various embodiments, for example, the edible particulate can comprise a blend of citric acid and sugar.

Another type of edible moisture-sensitive particulate that can be coated in accordance with this invention can be regarded as a finished food product which, itself, is moisture-sensitive and/or hygroscopic. Examples of this type of particulate include popping candy, sprinkles, dragées, nonpareils and comfits. As well understood in the art, popping candy (e.g., Pop Rocks) is a candy which is typically made with sugar, lactose and flavorings which creates a small popping reaction when it dissolves in the mouth. See, U.S. Pat. No. 3,012,893. Meanwhile, sprinkles (also known as sugar strands) are small pieces of confectionery used as a decoration or to add texture to desserts such as cupcakes, doughnuts or ice cream which are sprinkled randomly over a surface, rather than being placed in a specific spot. Nonpareils are a decorative confectionery of tiny balls made with sugar and starch, traditionally an opaque white but now available in many colors, while dragées are bite-sized forms of confectionery with a hard outer shell such as an M&M candy. Finally, comfits are confectioneries consisting of dried fruits, nuts, seeds or spices coated with sugar candy, an example of which is the almond comfit (also known as “sugar almonds” or “Jordan almonds”).

Still another type of edible particulate that can be coated in accordance with this invention is a particulate which contains a moisture-sensitive ingredient which is capable of leaching out of the particulate and dissolving in any moisture that might come into contact with the particulate after it has formed. An example of this type of particulate is a sprinkle containing a moisture-sensitive dye. Another example of this type of particulate is a nonpareil which, when mixed with yogurt, begins to dissolve in the yogurt soon after being mixed.

As indicated above, while many techniques have been used for applying protective coatings to edible particulates which are, or contain, moisture-sensitive and/or hygroscopic ingredients, most are limited in terms of the maximum particle size of the particulates that can be coated. In contrast, the inventive coating process is not so limited. Thus, this invention can easily be accomplished on edible particulates having a particle size of 200 mesh (74 microns) or more. Thus, edible particulates having a particle size of 100 mesh (149 microns) or more, 50 mesh (297 microns) or more, 30 mesh (595 microns) or more, 25 mesh (707 microns) or more, 20 mesh (841 microns) or more, 16 mesh (1190 microns) or more, 12 mesh (1680 microns) or more, 10 mesh (2000 microns) or more, or even 5 mesh (4000 microns) or more can be easily and conveniently process by the inventive coating technology. Although there is no upper limit to the particle size of these edible particulates, as a practical matter the maximum particle size of these particulates will normally be 3 cm, more typically 2 cm, 1 cm, 5 mm, 4 mm, 3 mm or even 2 mm, 1 mm, 0.5 mm, or even 0.25 mm.

As further indicated above, this invention is especially useful in connection with providing protective coatings on edible particulates having an irregular shape. In this context, an “irregular shape” will be understood to mean a shape which includes sharp edges and/or corners such as found in a cube or a right circular cylinder, for example. In addition, an “irregular shape” will also be understood to mean a shape having an aspect ratio of greater than 2.

### Protective Coating-Wax Coating Layer

The protective coating of the inventive coating technology is composed of at least two different coating layers, one being formed from wax and the other being formed from shellac.

The wax coating layer can be formed from naturally occurring waxes, synthetic waxes and mixtures thereof. Examples of waxes which are useful for this purpose include beeswax, carnauba wax, candelilla wax, soy wax, rice bran wax, shellac wax, paraffin wax, spermaceti, lanolin, bayberry, sugarcane, microcrystalline, petrolatum and carbowax. Mixtures of these waxes may also be used. Preferably, the wax being used is a powdered wax and is applied to the edible particulate substrate in a powdered form. In various embodiments, the wax being used can have a melting temperature between 25° C. and 100° C., more preferably between 40° C. and 90° C., and be applied to the edible particulate substrate in a molten or powdered form.

The wax coating layer can be composed entirely of wax. Alternatively, it can contain additional ingredients including co-film formers, lipids, stability control agents and rheology control agents. Examples of co-film formers which can be used for this purpose include various naturally-occurring resins such as wood resin and coumarone-indene resin; various proteins such as corn zein, wheat gluten, soy protein, peanut protein, keratin, collagen, gelatin, milk protein (casein) and whey protein; extrudate gums such as gum arabic, gum ghatti, gum karaya and gum tragacanth; seed gums such as guar gum and locust bean gum; microbial fermentation gums such as xanthan, gallan gum and chitosan; seaweed extracts such as agar, alginates, carageenans and furcellaran; pectins; and various different types of celluloses such as methyl and ethyl cellulose and their hydroxyl substituted analogs, microfibrillated cellulose, etc. Mixtures of these ingredients can also be used.

The total amount of co-film formers that can be included in the wax coating layer of this invention should not exceed 25 wt. %, based on the weight of the wax coating layer as a whole. More typically, the total amount of these ingredients will not exceed 20 wt. %, 15 wt. %, 10 wt. %, 7.5 wt. %, 5 wt. %, 2.5 wt. %, 1 wt. %, 0.5 wt. %, 0.2 wt. %, or even 0.1 wt. % on this basis. In some embodiments, the wax coating layer will be entirely free of co-film formers.

Examples of suitable lipids that that can be included in the wax coating layer of this invention include a fatty acid component in which the fatty acid contains 4 to 28 carbon atoms, with this fatty acid component being either in free form, i.e., a free fatty acid, or in the form of a mono-, di- or tri-glyceride. Mixtures of these ingredients can also be used. Naturally-occurring food grade fats and oils of both plant and animal origin can be used for this purpose. Specific examples of suitable lipids include vegetable stearines such as tristearin.

The total amount of lipids that can be included in the wax coating layer of this invention should also not exceed 25 wt. %, based on the weight of the wax coating layer as a whole. More typically, the total amount of lipids will not exceed 20 wt. %, 15 wt. %, 10 wt. %, 7.5 wt. %, 5 wt. %, 2.5 wt. %, 1 wt. %, 0.5 wt. %, 0.3 wt. %, 0.2 wt. %, or even 0.1 wt. % on this basis. In some embodiments, the wax coating layer will be entirely free of lipids.

In those embodiments in which the wax coating contains lipids, these lipids can be composed entirely of monoglycerides, diglycerides or triglycerides. In addition, they can also be comprised of mixtures of these glycerides in any relative amounts. Desirably, however, the total amount of diglycerides and monoglycerides in any such wax coating will be less than 0.5 wt. %, more typically be less than 0.4 wt. %, be less than 0.3 wt. %, be less than 0.2 wt. %, or even less than 0.1 wt. %. In some embodiments, the wax coating will be entirely free of diglycerides and monoglycerides.

Examples of suitable stability control agents and rheology control agents that can be included in the wax coating layer of this invention include the silicone-based antifoam agents and lecithin shown in the above-noted U.S. Pat. No. 5,126,151. Other wetting agents, as well as antioxidants can also be included. Mixtures of these ingredients can also be used. If present, the total amount of these ingredients in the wax coating layer should not exceed 5 wt. %, based on the weight of this layer. More typically, the total amount of these additional ingredients will not exceed 2 wt. %, 1 wt. %, 0.5 wt. %, 0.2 wt. %, or even 0.1 wt. % on this basis. Desirably, the wax coating layer is entirely free of stability control agents and rheology control agents.

The wax coating layers of the protective coating of this invention are also preferably free of residual amounts of harmful volatile organic solvents, especially halogenated organic solvents and petroleum ethers. As indicated above, U.S. Pat. No. 2,956,926 describes a solvent coating process for applying a wax protective coating to citric acid powder in which the wax is dissolved in a suitable volatile organic solvent, the composition so obtained pan coated onto the citric acid powder substrate, and the coated citric acid powder so made flushed with hot air to evaporate the volatile organic solvent and produce a solidified wax coating.

Although this patent indicates that the residual amounts of these volatile organic solvents which are left in such solid wax coatings are non-toxic, modern experience has shown that this is not the case. On the contrary, current understandings are that, even though the amounts of these residual solvents may be small, nonetheless they still raise serious health and safety concerns. Current U.S. health and safety regulations (e.g., the so-called Delaney Amendment, aka the Food Additives Amendment of 1958 to the United States Food, Drugs and Cosmetics Act of 1938) are also implicated.

In accordance with this invention, this problem is avoided by formulating and applying the wax coating layer of the inventive protective coating so that it is free of these residues—in particular, so that it is free of additives which are required to be excluded from foods under the Delaney Amendment and other applicable U.S. health and safety statutes and regulations (hereinafter “unsafe food ingredients”). As further discussed below, this is preferably done by applying the ingredients forming this wax coating layer to the edible particulates being coated in a powdered form, or by melting the ingredients forming this wax coating layer and then applying the molten wax coating composition so formed to the edible particulates being coated, preferably by pan coating techniques. Applying the wax in powdered form is preferred because it is believed to avoid unsafe volatile organic solvents.

### Protective Coating-Shellac Layer

The shellac coating layer which forms at least a portion of the protective coating of this invention can be formed from one or more suitable edible, film-forming resins, including any type of commercially-available shellac or shellac analog. In various embodiments, the shellac coating layer is ethanol soluble.

It should be understood that “shellac coating layer” as used herein refers to one or more edible, film-forming resins comprising shellac or a shellac analog, and because it can comprise a shellac analog it need not necessarily contain shellac itself. For example, suitable ethanol-soluble, edible, film-forming resins that can be used for this purpose include shellac, zein, ethyl cellulose, and certain grades of hydroxypropyl cellulose. Mixtures of these edible, film-forming resins can also be used. Shellac, zein and mixtures thereof are preferred.

Shellac is a naturally occurring thermoplastic obtained from secretions of the female lac bug. It exhibits a remarkable combination of properties including low permeabilities to oxygen, water vapor, CO2, ethylene and various odors. In addition, it also exhibits low lipid solubility, excellent color and excellent clarity.

Shellac is obtained from seedlac, an insect secretion, by removing debris from the seedlac and then further processing the seedlac to obtain the desired product. Commercially, shellac is available in two different types, bleached shellac and orange shellac. Moreover, both of these shellacs are available in refined (i.e., dewaxed) as well as unrefined (regular) versions. In addition, each of these four different varieties of shellac are available in different physical forms, e.g., solid flakes and aqueous and/or alcohol solutions. In addition, some of these different varieties are also available in different grades. For example, dewaxed orange shellac is available in a variety of different grades ranging from faint orange to intense orangish red.

As described in U.S. Pat. No. 6,348,217, the entire disclosure of which is incorporated herein by reference, bleached shellac is made by dissolving seedlac in aqueous alkali and then adding a bleaching agent such as sodium hypochlorite. The product so obtained is then precipitated and dried to produce regular bleached shellac. Alternatively, the dissolved bleached shellac can be refined by known techniques to remove its wax content before precipitating and drying, thereby producing dewaxed bleached shellac. In contrast, regular orange shellac is made by melting seedlac, sieving out the insolubles and then solidifying and flaking the product so obtained. Meanwhile, dewaxed orange shellac is made by dissolving the seedlac in alcohol, straining out the insolubles, filtering out wax particles and passing the solution so obtained through activated carbon to decolorize before solidifying and flaking. In accordance with this invention, each of these different types of shellac can be used in embodiments of the present disclosure.

Zein is a class of prolamine proteins found in maize (corn). Pure zein is water-insoluble, ethanol-soluble and edible. It is usually manufactured as a powder from corn gluten meal and has a variety of different uses including coatings for candy, nuts, fruit, pills, other encapsulated foods and drugs, paper cups, soda bottle cap linings, clothing fabrics and the like.

Ethyl cellulose is a derivative of cellulose in which some of the hydroxyl groups on the repeating glucose units are converted into ethyl ether groups. It is also colorless, odorless, tasteless, hard, water-insoluble, ethanol-soluble and edible. It is widely available commercially and mainly used as a thin-film coating material for coating paper, vitamin and medical pills, and for thickeners in cosmetics and in industrial processes.

Hydroxypropyl cellulose, is an ether of cellulose in which some of the hydroxyl groups in the repeating glucose units have been hydroxypropylated, normally using propylene oxide. Depending on the extent of hydroxypropylation, molecular weight and other factors, some grades of hydroxypropyl cellulose are soluble in ethanol, other grades are soluble in water, while still others are soluble in mixtures of ethanol and water.

The shellac coating layer of this invention can be composed entirely of one or more suitable ethanol-soluble, edible, film-forming resins, as described above. This coating layer can contain organic-origin, water vapor-impermeable and film forming materials, other organic-origin, film forming materials (i.e., those not being water vapor-impermeable), plasticizers, detackifiers and coloring agents. The organic-origin, water vapor-impermeable and film forming materials and organic-origin, film forming materials (i.e., those not being water vapor-impermeable) may be the same or different as the one or more suitable ethanol-soluble, edible, film-forming resins, as described above.

Specific examples of organic-origin, water vapor-impermeable and film forming materials are certain polysaccharides including cellulose and its derivatives such as hydroxyethyl cellulose (HEC), hydroxypropyl cellulose, ethyl cellulose and microcrystalline cellulose; lipids and resins including waxes and oils such as paraffin wax, carnauba wax, beeswax, candelilla wax and polyethylene wax; fatty acids and monoglycerides such as stearyl alcohol, stearic acid, palmitic acid, mono-, di- and tri-glycerides; naturally-occurring resins such as wood resin and coumarone-indene; and proteins including corn zein (a-zein, b-zein and/or v-zein), wheat gluten, soy protein, peanut protein, keratin, collagen, gelatin, milk protein (casein) and whey protein. Mixtures of these materials can also be used.

Meanwhile, specific examples of other organic-origin, film forming materials include certain types of polysaccharides such as carboxymethyl cellulose (CMC), methyl cellulose (MC), hydroxypropyl cellulose, hydroxypropyl methylcellulose (HPMC) and microcrystalline cellulose; starches and derivatives such as raw starch, modified starch, pregelatinized starch, dextrin, maltodextrin, corn syrup sucrose, dextrose/fructose and sugar polyols; extrudate gums such as gum arabic, gum ghatti, gum karaya and gum tragacanth; seed gums such as guar gum and locust bean gum; microbial fermentation gums such as xanthan, gallan gum and chitosan; seaweed extracts such as agar, alginates, carageenans and furcellaran; and pectins.

Specific examples of suitable plasticizers include glycols such as polyethylene glycol (PEG), polypropylene glycol (PPG), etc., lipids such as vegetable oils, mineral oils, medium chain triglycerides, fats, fatty acids, waxes, etc. Specific examples of suitable detackifiers include proteins such as zein, etc. and lipids such as acetylated monoglycerides, medium chain triglycerides, oils, waxes, fatty acids such as stearic acid and oleic acid, etc. Specific examples of suitable coloring agents include pigments such as organic pigments and inorganic pigments, dyes and other naturally occurring colorants.

The shellac coating layer will normally contain at least about 50 wt. % of the edible, film-forming resin, e.g., shellac, based on the weight of this coating layer. More commonly, this coating layer will contain about 65 wt. %, 75 wt. %, 85 wt. % or even 95 wt. % or more of the edible, film-forming resin. In addition, this shellac coating layer may also contain up to about 40 wt. % co-film former (a shellac analog or other naturally-occurring film former), although co-film former amounts on the order of up to about 30 wt. %, up to about 20 wt. % or even up to about 10 wt. % are more common. If used, the co-film former will normally be present in an amount sufficient to achieve a noticeable change in the properties of the protective coating, usually at least about 0.5 wt. %, 1 wt. %, 2 wt. % or even 5 wt. % on the same basis.

In addition, this shellac coating layer may also contain about 0-50 wt. % detackifier, although detackifier concentrations on the order of >0 to 40 wt. %, about 3 to 35 wt. % or even about 5-35 wt. % are more common. Similarly, the inventive protective coatings may contain about 0-50 wt. % plasticizer, although plasticizer concentrations on the order of >0 to 40 wt. %, about 3 to 35 wt. % or even about 5-35 wt. % are more common. Finally, the amount of coloring agent included in the shellac coating layer should be enough to develop the necessary color and will typically be between about 0.1 to 3 wt. %, more commonly about 0.3 to 2 wt. % or even 0.4 to 1 wt. %, although amounts up to about 50 wt. % can be used.

### Pan Coating

The protective coating of this invention can be applied by pan coating techniques. Pan coating is a well-known type of coating technique in which a liquid coating composition is applied, usually by spraying, to a batch of particulate materials being carried in a rotating pan, followed by solidification of the coating composition to form a solid protective coating. It is widely used in the pharmaceutical industry for coating tablets as well as the food industry for coating small pieces of candy and other confectionaries. The rotating pan “fluidizes” the particulates being coated by causing them to tumble and hence cascade over one another, thereby ensuring that a uniform coating is ultimately obtained even when the particulates are irregular in shape.

### Shellac Coating Layer

The shellac coating layer of this invention can be applied by pan coating techniques. For this purpose, the shellac coating can be dissolved or dispersed in a suitable carrier liquid.

In this regard, shellac is readily soluble in alcohol, especially ethanol, as well as water having an alkaline pH. Although shellac is insoluble in water of a neutral or acidic pH, it can easily be dispersed in these waters.

Although all of these shellac solutions and dispersions can be used for producing the shellac coating layer of this invention, it is desirable that a solution of shellac in a suitable alcohol be used for this purpose. In this context, “solution” as used in this disclosure will be understood to mean a true solution in which the solute (shellac) is dissolved in the solvent (carrier liquid) as opposed to a dispersion in which particles of shellac are dispersed in the carrier liquid. Alcohol solutions are preferable, since it has been found that they provide protective coatings with the best barrier properties. For this purpose, low molecular weight alcohols, i.e., C1-C6 alcohol containing 1 to 5 hydroxyl groups are preferably used.

Regardless of the particular type of shellac coating composition used, the concentration of carrier liquid in this coating composition can vary widely, and essentially any amount can be used. Concentrations of carrier liquid on the order of about 20 to 90 wt. % or more are possible, based on the total weight of the shellac coating composition, although concentrations on the order of 40 to 85 wt. %, 55 to 75 wt. % are more common.

The shellac coating composition can be applied at any convenient temperature, from as low as room temperature (e.g., 68° F., 20° C.) or lower to as much as 190° F. (˜88° C.) or more. In this context, the temperature of the shellac coating composition will be understood to mean the temperature that this composition assumes as it is being coated onto the particulates being coated, which temperature can arise from heating the coating composition before or after it is applied, from the latent heat in the particulates being coated, or from both.

Normally the shellac coating composition will be applied at temperatures of about room temperature or less to about 150° F. (˜66° C.), more typically from temperatures as low as room temperature or less to temperatures as high as about 100° F. (˜38° C.), 90° F. (˜32° C.), or even 80° F. (˜27° C.). Using lower temperatures, e.g., room temperature ±10° F. (±˜6° C.), or even ±5° F. (±˜3° C.) may be helpful in avoiding agglomeration of the particulates being coated.

After application of the shellac coating composition, the coated granules can be heated, if desired, although this is unnecessary. In addition to accelerating evaporation of the carrier liquid, heating of the shellac coating also helps to prevent immediate solidification of a subsequently applied molten wax coating. In any event, heating of the shellac coated granules is entirely optional. If heating is done, the temperature of the granules being coated desirably should not exceed about 190° F. (˜88° C.).

### Declumping Drum

In order to help break up and comminute any agglomerates that my form during pan coating, one or more declumping drums can be placed in the pan of the pan coating machine.

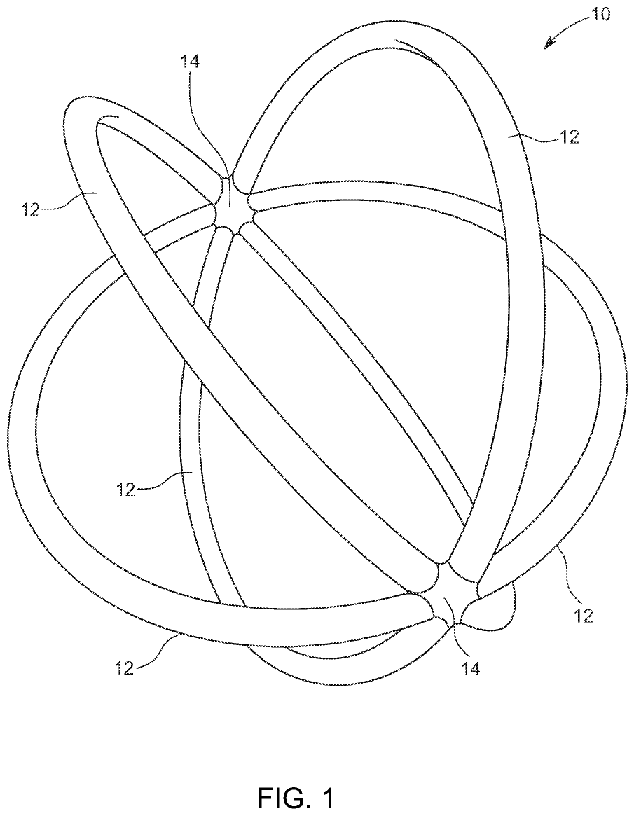

Such a declumping drum is illustrated in FIG. 1, which shows declumping orb or sphere 10 being formed from six semicircular members 12 such as hollow tubes of equal size welded together at their ends 14 in a manner so that these members all lie in a common sphere. When placed in the pan of a typical pan coating machine, gravity causes declumping orb 10 to roll over the contents of the pan as it rotates, thereby mechanically working these contents by an amount which is sufficient to break apart and help comminute any agglomerates that may have formed but not so much as to ruin the coating that is being formed.

Declumping drum 10 has an essentially circular periphery. In this context, “essentially circular periphery” will be understood to mean a three dimension shape which is such that, when placed on the contents of the pan of a pan coating machine, rotation of the pan will cause the drum to roll over these contents, thereby breaking apart and helping to comminute any agglomerates that may have formed. Examples of articles having a circular periphery include cylinders, spheres, cones, spheroids, etc.

In this regard, as made clear from the above discussion of declumping orb 10, the outer surface of an article need not be smooth or continuous in order for that article to have a “circular periphery” in the context of this disclosure. On the contrary, declumping orb 10 has a “circular periphery,” because the six semicircular hollow tubes from which it is formed all lie in a common sphere and further because these tubes are close enough together so that rotation of the pan of a pan coating machine will cause it to roll over the contents of the pan.

In the same way, other articles having protrusions, projections, ribs, knobs, knurls, bulges, bumps, lands or other protuberances which together define a three dimensional shape with a circular periphery will also be understood as having a circular periphery so long as these protrusion are close enough together so that the article will roll from the rotation of the pan of a pan coating machine. For example, an article in the shape of a football having enough protruding ribs of equal height so that it will roll in the rotating pan of a pan coating machine will be understood to define a circular periphery because the outer surfaces of these protruding ribs all lie along a common spheroid.

Normally, gravity alone will be sufficient to cause drum 10 to roll over the contents of the pan as it rotates. However, other motive means such as a motor or appropriate gearing can also be used for this purpose.

### Molten Wax

With regard to applying a molten wax coating composition, in accordance with this invention, pan coating techniques can be used to apply one or both coating layers of the inventive protective coating, i.e., both the wax coating layer and the shellac coating layer. This can be done either in batch operation or continuously for each coating layer, independently of the other. Although the wax coating layer of this invention is preferably applied in powdered form, in various embodiments, the wax coating layer of this invention can be made liquid by dissolving and/or dispersing it in a suitable carrier liquid, or by melting it with heat. Any type of equipment and/or procedure which will heat the wax coating layer to its melting temperatures can be used for this purpose. For example, a molten wax coating composition can be separately prepared remote from the pan coating machine and then sprayed or otherwise deposited on the contents of the rotating pan of the pan coating machine.

Additionally, and/or alternatively, the pan coating machine can be equipped with a heater element arranged to apply heat to the contents of the pan, either directly or indirectly by applying heat to the outside of the pan for transfer to the contents inside the pan. Such a heater can be used to supply all of the heat needed to melt the wax coating composition or, alternatively, to supply just enough heat to keep an already-molten wax coating composition molten long enough to complete the coating operation, or a combination of both.

To ensure that the wax coating composition is fully melted, the temperature to which the wax coating composition should be heated will generally be between about 140° F. (˜60° C.) and 190° F. (˜88° C.) or even 212° F. (100° C.), depending on the particular wax or waxes used to form this coating layer. Heating of the wax coating composition can be done by heating the particulates being coated before the wax coating is applied. If so, some or all of the heat needed to melt the wax coating can be supplied in this manner. Alternatively or additionally, the wax coating can be heated before it is applied.

### Powdered Wax

In various embodiments, the shellac coating layer is applied to the edible particulate substrate first, and the wax coating layer is subsequently applied as a powder. As described herein, the shellac coating layer can be applied by pan coating techniques. The wax coating layer can be applied by pan coating techniques. In various embodiments, the wax coating layer can be applied with as a drip coating, for example with a ladle. In various embodiments, the wax coating layer can be applied by the same method used to apply the shellac coating layer.

As stated above, the wax coating layer can be formed from naturally occurring waxes, synthetic waxes and mixtures thereof. Examples of waxes which are useful for this purpose include beeswax, carnauba wax, candelilla wax, soy wax, rice bran wax, shellac wax, paraffin wax, spermaceti, lanolin, bayberry, sugarcane, microcrystalline, petrolatum and carbowax. Mixtures of these waxes can also be used.

In various embodiments, the powder used as wax coating layer can have a particle size of 325 mesh (44 microns), 270 mesh (53 microns), 200 mesh (74 microns), 140 mesh (105 microns), 100 mesh (149 microns), 50 mesh (297 microns), 30 mesh (595 microns), 25 mesh (707 microns), or even 20 mesh (841 microns). In various embodiments, the powder used as wax coating layer can have a particle size between 325 mesh (44 microns) and 20 mesh (841 microns), including between 270 mesh (53 microns) and 25 mesh (707 microns), between 200 mesh (74 microns) and 30 mesh (595 microns), or even between 140 mesh (105 microns) and 50 mesh (297 microns). In various embodiments, the powder used as wax coating layer can have a particle size smaller than 325 mesh (44 microns), for example 400 mesh (37 microns), or 500 mesh (25 microns) or smaller.

### Coating Order

The order in which the wax coating layer and the shellac coating layer are applied to the edible particulate substrate is not critical and either coating layer can be applied first followed by the other coating layer second. Thus, in some embodiments of this invention, the wax coating layer will be directly applied to the particulate substrate, while in other embodiments the shellac coating layer can be directly applied to the particulate substrate. In both cases, i.e., whether the wax coating layer or the shellac coating layer is applied first, the protective coating can be made from multiple wax coating layers, multiple shellac coating layers, or both.

Because edible particulate substrates are typically irregular in shape, forming the protective coating of this invention so that its outside surface is defined by a wax coating layer may be beneficial in those situations in which protecting the physical integrity of the protective coating during transport is desired due to the relatively softer nature of the wax coating. In contrast, if achieving a more attractive appearance is desired, forming the protective coating of this invention so that its outside surface is defined by a shellac coating layer may be more appropriate due to its relatively glossier appearance.

Also, the protective coating of the inventive granular food product is preferably formed solely from one or more wax coating layers and one or more shellac coating layers. In other words, preferably, the only protective coatings that are present in the inventive granular food product are the wax coating layers and the shellac coating layers which form the protective coating of this invention.

### Coating Amounts

A particular advantage of this invention is that the protective layer that is formed exhibits excellent barrier properties even though the total amount of protective coating which is added is very small in comparison to other protective coatings which have been applied to edible moisture-sensitive particulates. Thus, the total amount of the protective coating used in accordance with this invention will generally be no more than about 20 wt. %, based on the weight of the edible particulates being coated. More commonly, the total amount of the protective coating will be no more than about 15 wt. %, no more than about 10 wt. %, no more than about 8 wt. %, no more than about 6 wt. %, no more than about 5 wt. %, and even no more than about 4 wt. % on the same basis. Conversely, the minimum amount of protective coating will normally be at least about 0.6 wt. % on this basis, although amounts of at least about 1.00 wt. %, at least about 1.25 wt. %, at least about 1.5 wt. %, at least about 1.75 wt. % or even at least about 2 wt. % are contemplated.

In various embodiments, the total amount of the protective coating used in accordance with this invention is between 0.6 wt. % and 20 wt. % based on the weight of the edible particulates being coated. In various embodiments, the total amount of the protective coating used in accordance with this invention is between 1.00 wt. % and 15 wt. %, between 1.25 wt. % and 10 wt. %, between 1.5 wt. % and 8 wt. %, between 1.75 wt. % and 6 wt. %, and even between 2 wt. % and 5 wt. % on the same basis.

As for the individual coating layers, the total amount of the wax coating layer or layers will generally be no more than about 10 wt. %, based on the weight of the edible particulates being coated. More commonly, the total amount of the wax coating layer or layers will be no more than about 7.5 wt. %, no more than about 5 wt. %, no more than about 4 wt. %, no more than about 3 wt. %, and even no more than about 2 wt. % on the same basis. Conversely, the minimum amount of the wax coating layer or layers will normally be at least about 0.3 wt. %, at least about 0.5 wt. %, at least about 0.75 wt. % on this basis, although amounts of at least about 1.0 wt. %, at least about 1.2 wt. %, at least about 1.4 wt. %, or even at least about 1.6 wt. % are more common.

In various embodiments, the total amount of the wax coating layer or layers used in accordance with this invention is between 0.3 wt. % and 10 wt. % based on the weight of the edible particulates being coated. In various embodiments, the total amount of the protective coating used in accordance with this invention is between 0.5 wt. % and 7.5 wt. %, between 1.0 wt. % and 5 wt. %, between 1.2 wt. % and 4 wt. %, between 1.4 wt. % and 3 wt. %, and even between 1.6 wt. % and 2 wt. % on the same basis.

Similarly, the total amount of the shellac coating layer or layers will generally be no more than about 15 wt. %, based on the weight of the edible particulates being coated. More commonly, the total amount of the shellac coating layer or layers will be no more than about 10 wt. %, no more than about 7.5 wt. %, no more than about 5 wt. %, no more than about 2.5 wt. %, and even no more than about 2 wt. % on the same basis. Conversely, the minimum amount of the shellac coating layer or layers will normally be at least about 0.3 wt. % on this basis, although amounts of at least about 0.5 wt. %, at least about 0.75 wt. %, at least about 1.0 wt. %, at least about 1.25 wt. %, or even at least about 1.5 wt. % are more common.

In various embodiments, the total amount of the wax coating layer or layers used in accordance with this invention is between 0.3 wt. % and 15 wt. % based on the weight of the edible particulates being coated. In various embodiments, the total amount of the protective coating used in accordance with this invention is between 0.5 wt. % and 10 wt. %, between 0.75 wt. % and 7.5 wt. %, between 1 wt. % and 5 wt. %, between 1.25 wt. % and 2.5 wt. %, and even between 1.5 wt. % and 2 wt. % on the same basis.

In various embodiments, the total amount of the wax coating layers in the granular food product is no more than 10 wt. %, the total amount of the shellac coating layers in the granular food product is no more than 15 wt. %, and the total amount of the protective coating in the granular food product is no more than 20 wt. %, these percentages being based on the weight of the edible moisture-sensitive particulate substrate

Note that these coating amounts are far less than those used in earlier technologies for forming protective coatings on edible particulates such as those described in the Background section of this disclosure, which typically require coating amounts of at least 25 wt. %, and more typically at least 40 to 50 wt. %, to achieve an acceptable level of performance. This reduction in the amount of coating needed to achieve acceptable barrier property performance, when coupled with the simple and inexpensive coating techniques by which the inventive protective coating can be applied, makes the inventive coating technology especially desirable in connection with making storage-stable, moisture-resistant, edible moisture-sensitive particulates.

### EXAMPLES

In order to more thoroughly describe the subject matter of this invention, the following working examples are provided.

### Example 1

5000 g of 30 mesh citric acid granules were added to the continuously rotating pan of a laboratory scale pan coating machine, and the rotational speed of the pan adjusted so that the citric acid granules tumbled over one another in a cascading fashion, thereby “fluidizing” these granules. The granules were then directly heated to 145° F. (˜63° C.) with a heating gun.

200 g of a shellac coating composition comprising a solution of 40 wt. % regular bleached shellac dissolved in 60 wt. % ethanol was then added by hand. After the shellac coating composition had uniformly coated the citric acid granules, which took about 1 minute, forced air at room temperature was directed at the coated granules to promote evaporation of the ethanol and cool the granules.

Cooling and tumbling of the granules continued in this way for about 20 minutes. Since this was a laboratory scale experiment, a perforated ladle was used to break up any agglomerates that had formed. The shellac-coated granules were then heated to a temperature of about 190° F. (˜88° C.) to prevent immediate solidification of the subsequently applied wax coating, and a molten wax coating composition comprising 75 g of carnauba wax previously heated to about 194° F. (90° C.) was added.

Rotation of the coating pan continued until the wax coating composition had uniformly coated the shellac-coated citric acid granules, which took about 1 minute. During that time, a perforated ladle was used to break up any agglomerates that had formed. Forced air at room temperature was then directed at the coated granules to cool them to 85° F. (˜29° C.), thereby producing the product of this example comprising citric acid granules carrying a protective coating comprising 1.6 wt. % of a shellac coating layer and 1.5 wt. % of a wax coating layer, based on the weight of the citric acid granules.

### Example 2

2100 g of 30 mesh colored sucrose granules were added to the continuously rotating pan of a laboratory scale pan coating machine, and the rotational speed of the pan adjusted so that they tumbled over one another in a cascading fashion, thereby “fluidizing” these granules.

The granules were then heated to 190° F. (−88° C.), after which 31.5 g of a molten wax coating composition at a temperature of about 194° F. (90° C.) and comprising a blend of 90 wt. % carnauba wax and 10 wt. % beeswax was added. Rotation of the coating pan continued until the wax coating composition had uniformly coated the sucrose granules, which took about 1 minute. During that time, a perforated ladle was used to break up any agglomerates that had formed. Forced air at room temperature was then directed at the coated granules to cool them to 145° F. (˜63° C.), thereby producing sucrose granules coated with a solidified wax coating layer.

37 g of a shellac coating composition comprising a solution of 40 wt. % regular bleached shellac dissolved in 60 wt. % ethanol was then added by hand. After the shellac coating composition had uniformly coated the sucrose granules, which took about 1 minute, forced air at room temperature was used to promote evaporation of the ethanol and cool the granules. Cooling and tumbling of the granules continued in this way, with any agglomerates that formed being broken up by hand with a perforated ladle.

After 7 minutes of continued pan rotation and cooling, an additional 34 g of the above shellac coating composition was added. Pan rotation, cooling and breaking up of agglomerates in the same way as described above continued for an additional 9 minutes, after which an additional 13 g of the above shellac coating composition was added. Pan rotation, cooling and breaking up of agglomerates in the same way as described above continued for an additional 6 minutes, thereby producing the final product of this example comprising sucrose granules carrying a protective coating comprising 1.5 wt. % of a wax coating layer, 0.70 wt. % of a first shellac coating layer, 0.65 wt. % of a second shellac coating layer, and 0.25 wt. % of a third shellac coating layer, based on the weight of the sucrose granules.

### Example 3

4000 g of 16 mesh citric acid granules and 48 g of a powdered wax blend comprising 90 wt. % carnauba wax and 10 wt. % beeswax was added to the continuously rotating pan of a laboratory scale pan coating machine. Rotation of the pan continued until a uniform granule/powdered wax mixture was obtained, which took about 1 minute.

The granules were then heated to 190° F. (˜88° C.) until the wax blend had completely melted and a uniform wax coating had formed. This took approximately 20 minutes, during which time any agglomerates that had formed were broken up by hand with a perforated ladle.

The contents of the rotating pan were then cooled to 145° F. (˜63° C.) using forced air at room temperature, after which 80 g of a shellac coating composition comprising a solution of 40 wt. % regular bleached shellac dissolved in 60 wt. % ethanol was added by hand. After the shellac coating composition had uniformly coated the citric acid granules, which took about 1 minute, forced air at room temperature was directed at the coated granules to promote evaporation of the ethanol and cool the granules.

Cooling and tumbling of the coated granules continued in this way for an additional 30 minutes, during which time any agglomerates that had formed were broken up by hand. Then, an additional 80 g of the above shellac coating composition was added, after which the above tumbling and cooling steps as described above were repeated, including breaking up of agglomerates by hand.

After an additional 30 minutes of cooling and tumbling, an additional 48 g of the above powdered wax blend was added. After 1 minute of pan rotation, the rotating pan of the machine was heated to and maintained at 190° F. (˜88° C.) until the powdered wax blend had melted and a uniform molten wax coating had formed, which took an additional 30 minutes. Any agglomerates that had formed during that time were broken up by hand.

Forced air was then used to cool the coated granules and solidify their molten wax coatings, thereby producing the product of this example comprising citric acid granules carrying a protective coating comprising 1.2 wt. % of a first wax coating layer, 0.8 wt. % of a first shellac coating layer, 0.8 wt. % of a second shellac coating layer, and 1.2 wt. % of a second wax coating layer, based on the weight of the citric acid granules.

### Example 4

22.68 kg of citric acid granules were added to the continuously rotating pan of a laboratory scale pan coating machine, and the rotational speed of the pan adjusted so that the citric acid granules tumbled over one another in a cascading fashion, thereby “fluidizing” these granules.

954 g of a shellac coating composition comprising a solution of 40.81 wt. % shellac dissolved in 59.19 wt. % ethanol was then added by hand at room temperature. The declumping orb of FIG. 1 was then placed in the pan to help uniformly distribute the shellac coating.

Tumbling of the granules with the declumping orb continued until essentially all of the ethanol had evaporated, about 30 minutes, thereby producing an essentially free-flowing mass of citric acid granules each carrying its own uniform coating of shellac. The declumping orb was then removed from the pan, after which the shellac-coated granules were heated to a temperature of about 190° F. (˜88° C.) to prevent immediate solidification of the subsequently applied wax coating, and a molten wax coating composition comprising 340 g of carnauba wax previously heated to about 194° F. (90° C.) was added.

Rotation of the coating pan continued until the wax coating composition had uniformly coated the shellac-coated citric acid granules, which took about 5 minute. During that time, a perforated ladle was used to break up any agglomerates that had formed. Forced air at room temperature was then directed at the coated granules to cool them to 85° F. (˜29° C.), thereby producing the product of this example comprising citric acid granules carrying a protective coating comprising 1.6 wt. % of a shellac coating layer and 1.5 wt. % of a wax coating layer, based on the weight of the citric acid granules.

### Example 5

187.0 lbs of citric acid granules (sieving through 10 mesh) were added to a continuously rotating pan, and the rotational speed of the pan was adjusted (e.g., to about 30 rpm) so that the citric acid granules tumbled over one another in a cascading fashion, thereby “fluidizing” these granules.

10.0 lbs of a shellac coating composition comprising a solution of 40.81 wt. % regular bleached shellac dissolved in 59.19 wt. % ethanol was then added by hand. The declumping orb of FIG. 1 was then placed in the pan to help uniformly distribute the shellac coating. From time to time, a paddle was used to break up any agglomerates that had formed and any material stuck to the wall of the pan was scraped off. Tumbling of the granules with the declumping orb continued in this way for about 60 minutes. The declumping orb was then removed from the pan.

3.0 lbs of a wax coating composition comprising 200 mesh carnauba wax powder was added. Rotation of the coating pan continued until the wax coating composition had uniformly coated the shellac-coated granules, which took between about 15 minutes and 30 minutes, thereby producing the product of this example comprising granules carrying a protective coating comprising 2.2 wt. % of a shellac coating layer and 1.6 wt. % of a wax coating layer, based on the weight of the citric acid granules.

### Example 6

Commercially available edible fruit strips were coated with edible moisture-sensitive particulate substrates according to various aspects of this invention. Specifically, three groupings of moisture-sensitive particulate substrates were produced.

The first group of moisture-sensitive particulate substrates (“Group 1”) comprised a blend of 33 wt. % citric acid granules and 67 wt. % sugar granules. Commercially available edible fruit strips were then coated with the moisture-sensitive particulate substrates of Group 1.

The second group of moisture-sensitive particulate substrates (“Group 2”) comprised a blend of the substrates according to Example 5 (33 wt. %) and sugar granules (67 wt. %). Commercially available edible fruit strips were then coated with the moisture-sensitive particulate substrates of Group 2.

The third group of moisture-sensitive particulate substrates (“Group 3”) comprised a blend of the substrates according to Example 4 (33 wt. %) and sugar granules (67 wt. %). Commercially available edible fruit strips were then coated with moisture-sensitive particulate substrates of Group 3. The fruit strips used in this Example 6 were identical such that the only difference in the samples were the moisture-sensitive particulate substrates of Groups 1-3.

The fruit strips coated with the substrates of Group 1, Group 2, and Group 3 were then exposed to an atmosphere with a temperature of 40 degrees Celsius and a relative humidity of 75% humidity, and the absorption of moisture into the substrates was observed over time. Specifically, the moisture absorbed by the substrates inversely correlated with the intensity of the white color of the substrates, with the intensity of the white color of the substrates decreasing as more moisture was absorbed by the substrates.

As shown in Table 1, the intensity of the white color of the moisture-sensitive particulate substrates was analyzed over time, with the number of plusses (+) corresponds to the intensity of the white color. Initially, the substrates of Group 1, Group 2, and Group 3 each had a white appearance (++++). As time progressed, moisture was absorbed into the substrates, and the corresponding white color of the substrates decreased in intensity.

Over 24 hours, Group 1, the uncoated substrates, absorbed moisture the fastest, resulting in the fastest decrease in the white appearance. Compared to the Group 1 substrates, the substrates of Group 2 and Group 3 exhibited a slower rate of moisture absorption. Group 3, the substrates coated in a molten wax coating layer and a shellac coating layer, absorbed moisture the slowest, as shown by the slowest decrease in white intensity of the substrates. Group 2, the substrates coated in a powder wax coating layer and a shellac coating layer, absorbed moisture at a rate between that of Group 1 and Group 3.

TABLE 1
Intensity of the White Color of the Substrates

| Time after | | | |
|---|---|---|---|
| exposure to an | | | |
| atmosphere with | | | |
| a temperature | | | |
| 40 degrees Celsius | | | |
| and a relative | | | |
| humidity of 75% | | | |
| humidity | Group 1 | Group 2 | Group 3 |
| 0 hours | ++++ | ++++ | ++++ |
| 1 hour | ++ | +++ | ++++ |
| 4 hours | No observable | ++ | +++ |
| | white | | |
| | appearance | | |
| 20 hours | No observable | + | ++ |
| | white | | |
| | appearance | | |
| 24 hours | No observable | No observable | No observable |
| | white | white | white |
| | appearance | appearance | appearance |

Although only a few embodiments of this invention have been described above, many modifications can be made without departing from the spirit and scope of this invention. All such modifications are intended to be included within the scope of this invention, which is to be limited only by the following claims.

1. A granular food product comprising:
an edible moisture-sensitive particulate substrate; and
a protective coating on the particulate substrate comprising one or more wax coating layers and one or more shellac coating layers,
wherein the total amount of the wax coating layers in the granular food product is no more than 10 wt. %, wherein the total amount of the shellac coating layers in the granular food product is no more than 15 wt. %, and wherein the total amount of the protective coating in the granular food product is no more than 20 wt. %, these percentages being based on the weight of the edible moisture-sensitive particulate substrate.

2. The granular food product of claim 1, wherein the one or more shellac coating layers directly contact the edible moisture-sensitive particulate substrate.

3. The granular food product of claim 1, wherein the one or more wax coating layers directly contact the edible moisture-sensitive particulate substrate.

4. The granular food product of claim 1, wherein the one or more wax coating layers were formed using powdered wax.

5. The granular food product of claim 1, wherein the one or more shellac coating layers comprise an ethanol-soluble, edible, film-forming resin.

6. The granular food product of claim 5, wherein the ethanol-soluble, edible, film-forming resin comprises one or more of shellac, zein, ethyl cellulose, and hydroxypropyl cellulose.

7. The granular food product of claim 1, wherein the total amount of the wax coating layers in the granular food product is at least 0.3 wt. %, wherein the total amount of the shellac coating layers in the granular food product is at least 0.3 wt. %, and the total amount of the protective coating in the granular food product is at least 0.6 wt. %, these percentages being based on the weight of the edible moisture-sensitive particulate substrate.

8. The granular food product of claim 1, wherein the edible moisture-sensitive particulate substrate has a particle size of at least 200 mesh (74 microns).

9. The granular food product of claim 1, wherein the edible moisture-sensitive particulate substrate is at least one of an organic (food grade) acid, a saccharide, a granulated sweetener that is liquid in origin, a popping candy, a sprinkle, a dragée, a nonpareil and a comfit.

10. The granular food product of claim 1, wherein the maximum particle size of the edible moisture-sensitive particulate substrate is 5 mm.

11. The granular food product of claim 1, wherein the shellac coating layer has been produced by depositing a liquid shellac coating composition directly or indirectly onto the edible moisture-sensitive particulate substrate and thereafter causing the liquid shellac coating composition to solidify, wherein the liquid shellac coating composition comprises a solution of shellac dissolved in a C₁-C₆ alcohol containing 1 to 5 hydroxyl groups.

12. The granular food product of claim 1, wherein the shellac coating layer is formed by pan coating techniques.

13. The granular food product of claim 1, wherein the wax coating layer is formed by pan coating techniques.

14. The granular food product of claim 1, wherein the protective coating consists solely of one or more wax coating layers and one or more shellac coating layers.

15. The granular food product of claim 1, wherein the wax coating layers are free of volatile halogenated organic solvents and petroleum ethers.

16. (canceled)

17. The granular food product of claim 1, wherein the edible moisture-sensitive particulate substrate is hygroscopic.

18. A process for making the granular food product of claim 1, wherein each of the one or more wax coating layers and each of the one or more shellac coating layers is formed by a pan coating technique.

19-25. (canceled)
